(19) United States
(12) Patent Application Publication
(10) Pub. No.: US 2026/0094302 A1
(43) Pub. Date: Apr. 2, 2026

(54) Method for positioning an industrial safety sensor in an industrial plant using augmented reality

(71) Applicant: SICK AG, Waldkirch (DE)

(72) Inventors: Jens GEBAUER, Waldkirch (DE); Heiko STEINKEMPER, Waldkirch (DE); Christoph HOFMANN, Waldkirch (DE)

(21) Appl. No.: 19/318,798

(22) Filed: Sep. 4, 2025

(30) Foreign Application Priority Data
Sep. 4, 2024 (DE) 102024125297.9

(51) Int. Cl. G06T 7/80; G06F 3/01; G06T 11/00

(52) U.S. Cl. CPC G06T 7/80; G06F 3/011; G06T 11/10; G06T 2200/24; G06T 2207/30204; G06T 2207/30244

(57) ABSTRACT

A method includes positioning at least one real sensor, in particular a safety sensor or a camera for industrial safety applications, in a real environment of an industrial plant by means of an augmented reality view based on the real environment of the industrial plant. At least one simulated parameter of a virtual sensor based on the real sensor to be positioned is visualized for a user in the augmented reality view by means of a display device. The simulated parameter includes at least one position parameter indicating a position and/or an orientation of the virtual sensor in the augmented reality view. A change of the position parameter is obtained and the position parameter that is updated based on the obtained change is visualized for the user in the augmented reality view by means of the display device. At least one output parameter enables positioning of the real sensor.

The invention relates to methods, to a display device and to a system for positioning at least one real sensor, in particular a safety sensor or a camera for industrial safety applications, in a real environment of an industrial plant by means of an augmented reality view.

Industrial safety sensors or cameras for industrial safety applications allow a safe environmental perception, in particular a safe three-dimensional environmental perception, with which the safety and efficiency of industrial processes in industrial plants can be increased. Examples of industrial safety sensors or cameras for industrial safety applications include ToF (Time of Flight) cameras, laser scanners, 2D cameras, 3D cameras, LiDAR (Light Detection And Ranging) sensors, radar sensors, ultrasonic sensors and others.

It is understood that an industrial plant is to be understood broadly here and can, for example, comprise a factory hall, a production plant, a warehouse, a logistics center, a livestock facility, a chemical industry plant, a waste incineration plant or a power plant. In the following, only a (real) sensor is mentioned, wherein both industrial safety sensors and cameras for industrial safety applications are meant.

As of today, the positioning and configuration of a real sensor in a real environment of an industrial plant requires a very high level of technical understanding and very good knowledge of the physical and technical operating principle of the sensor. Furthermore, real measurement data acquired with the pre-positioned real sensor are required that are displayed for the user in a purely virtual 3D configuration application. The user is then required to have an almost perfect imagination in order to transfer complex 3D transformations carried out in thought to the real application. It is understood that such a positioning and configuration process is also only possible if the real sensor is already pre-positioned and connected and real measurement data are available. However, for an initial positioning and configuration step, it is unclear whether the real sensor is even installed in a suitable position so that the sensory capabilities of the real sensor can be utilized in the application in the first place, or whether the detection zone of the sensor is even sufficient for the intended application.

It is the underlying object of the invention to improve the positioning of a real sensor in a real environment of an industrial plant and in particular to make the positioning easier for the user.

A method having the features of claim 1 is provided to satisfy the object. Advantageous embodiments of the invention can be seen from the dependent claims, from the description, and from the drawings.

In the method according to claim 1 for positioning at least one real sensor, in particular a safety sensor or a camera for industrial safety applications, in a real environment of an industrial plant by means of an augmented reality view, at least one simulated parameter of a virtual sensor is visualized for a user in the augmented reality view by means of a display device.

It is understood that when (at least) one real sensor is mentioned in the following, a plurality of real sensors can also be meant. The invention thus likewise relates to the positioning (and configuration) of a plurality of real sensors. The real sensor is preferably a ToF camera, a laser scanner, a 2D camera, a 3D camera, a lidar sensor, a radar sensor or an ultrasonic sensor.

According to the invention, the augmented reality view or augmented reality environment is based on the real environment of the industrial plant. The augmented reality view can, for example, be a view or representation of the real environment in the industrial plant, wherein visualizations of simulated elements can be inserted into the view or representation of the real environment.

According to the invention, the virtual sensor is based on the real sensor to be positioned. This can mean that the virtual sensor mirrors the real sensor to be positioned, is a model of the real sensor, and/or represents a virtual copy of the real sensor so that properties and/or parameters of the virtual sensor can be transferred to properties and/or parameters of the real sensor, and vice versa. For example, at least one property and/or parameter of the virtual sensor can be identical to a property and/or parameter of the real sensor to be positioned.

It is understood that each of the parameters mentioned below is also to be understood as a parameter set. For example, a parameter can comprise a plurality of values or can be a vector or array comprising a plurality of elements. Furthermore, it is understood that even if reference is made to one parameter, a plurality of parameters, and in particular a plurality of parameters with the same designation, can also be meant.

According to the invention, the at least one simulated parameter comprises at least one position parameter, wherein the at least one position parameter indicates a position and/or an orientation of the virtual sensor in the augmented reality view. It is understood that the position parameter simulates a (future) real position of the real sensor in the real environment for the user in the augmented reality view. The position parameter in particular represents an initial position parameter that can be changed and that can be updated based on the change.

In the method according to the invention, a change of the position parameter is further obtained and the position parameter that is updated based on the obtained change is visualized for the user in the augmented reality view by means of the display device. In this respect, it is likewise possible that the change is obtained by means of the display device and that the position parameter is updated by means of the display device. Additionally or alternatively, it is conceivable that at least one device that is separate from the display device, such as a computing unit or a processor, obtains a change of the position parameter, said change being captured by a camera or a user interface, updates the position parameter based on the obtained change, and transmits the updated position parameter to the display device and/or can be retrieved by the latter. The updated position parameter can then be visualized in the augmented reality view by means of the display device, for example, by updating and/or adapting a previous visualization of the (old) position parameter or adding a new visualization of the (updated) position parameter. Finally, in the method according to the invention, at least one output parameter is output that is based on the updated position parameter of the virtual sensor and that enables the positioning of the real sensor in the real environment. It is understood that the output parameter can comprise the position parameter and/or a conversion parameter obtained by converting the position parameter. Additionally or alternatively, the output parameter can indicate a position and/or an orientation of the virtual sensor relative to a position marker or the display device.

According to the invention, the output parameter enables the positioning of the real sensor in the real environment. In other words, the output parameter provides the information based on which the real sensor can be (manually or automatically) positioned in the real environment.

In other words, the invention is based on the idea of providing the user with the possibility of planning, adjusting and/or optimizing the positioning, and preferably also the configuration, of the safety sensor (in particular in three dimensions) from the user's own perspective by means of a spatial visualization in the augmented reality view. Using the augmented reality view, the user can easily and flexibly test at which position the real sensor should be positioned and/or mounted (in future) in the real environment of the industrial plant. The same or similar applies to the configuration of protective and warning fields for laser scanners or protective and warning volumes for cameras or radar sensors. The dimensioning and orientation of the virtual sensor can be easily and flexibly adjusted and its visualization in the augmented reality view can be easily and flexibly inserted and/or updated. The positioning (and preferably also the configuration) of the virtual sensor is then output by means of an output parameter and can ideally be transferred to the positioning of the real sensor in the real environment of the industrial plant.

In short, a model of at least one real sensor can be positioned (and/or configured) in the augmented reality view and the real sensor can then be positioned (and/or configured) in the real environment on the basis of this positioning (and/or configuration) of the virtual sensor.

In contrast to the previous procedure, the real sensor does not necessarily have to be available in this respect and no real data acquired with the real sensor have to be available. The position of the virtual sensor can be easily and flexibly adjusted and optimized in the augmented reality view that is based on the, in particular three-dimensional, space of the real environment. It is conceivable that the protective field, field of vision and/or field-of-view (FOV) of the virtual sensor is/are additionally visualized. The so-called protective field is a part of the field of view, wherein a warning signal can be output if the protective field is violated, e.g. by a person or a robot, in particular an autonomous robot. The protective field of the virtual sensor can cover the entire field of view of the virtual sensor or only a portion of the field of view of the virtual sensor. The same applies to the real sensor. It is also conceivable that a selection of a plurality of (different) real and correspondingly virtual sensors is made possible in the method so that the optimal sensor can be found for each application.

In general, the inherently complex process of positioning (and preferably also configuring) a safety sensor in an environment of an industrial plant can be improved and can in particular be made simpler.

Furthermore, a plurality of virtual sensors can be positioned substantially at the same time or in a single method run-through so that, for example, gaps between the monitored zones of the virtual sensors and real barriers (e.g. walls) in the real environment can be detected and eliminated. A plurality of sensors (and corresponding protective fields) can also be optimally matched to one another. This can in particular be advantageous if a seamless monitoring of a large protective field, which can only be covered by a large number of sensors, or a targeted overlapping of protective fields is desired in order, for example, to achieve an increased safety via redundant monitoring in particularly critical regions of the industrial plant. In this respect, it is conceivable that overlapping regions of the protective fields of a plurality of virtual sensors could likewise be calculated and visualized, for example by a different coloring, in the augmented reality view. Furthermore, the method can be realized in a computer-implemented and in particular in a web-based manner so that an expert can be consulted by means of digital remote communication, for example.

According to one embodiment, the at least one position parameter of the virtual sensor comprises an x-coordinate value, a y-coordinate value, a z-coordinate value, and/or an alignment angle of the virtual sensor. The alignment angle of the virtual sensor can comprise an azimuth angle and/or an elevation angle of the line of sight of the virtual sensor.

According to one embodiment, the at least one simulated parameter of the virtual sensor that is visualized in the augmented reality view additionally comprises at least one configuration parameter that indicates a configuration of the virtual sensor. Preferably, the at least one configuration parameter of the virtual sensor corresponds to at least one possible configuration of the real sensor. In the method, a change of the (initial) configuration parameter can then, alternatively or additionally, be obtained. The configuration parameter that is updated based on the obtained change is visualized for the user in the augmented reality view by means of the display device, for example, by adaptively adjusting the previous visualization or by adding a new visualization. A further output parameter is furthermore output that is based on the updated configuration parameter of the virtual sensor and that enables the configuration of the real sensor in the real environment. It is understood that the output parameter that is based on the updated position parameter and the further output parameter that is based on the updated configuration parameter can be output substantially together or offset in time, and can in particular be output as a single parameter and/or as a parameter set.

According to one embodiment, the at least one configuration parameter of the virtual sensor comprises a maximum field of view, a portion of the maximum field of view, an orientation, a size and/or an extent of a protective field or warning field, a range, and/or a resolution of the virtual sensor. The range of the sensor can mean a maximum extent of the protective field of the sensor in front of a background and/or into the free space. Preferably, the configuration parameter of the virtual sensor is based on or corresponds to a possible configuration parameter of the real sensor so that the configuration parameter of the virtual sensor can be transferred to the real sensor, and vice versa.

According to one embodiment, the position of the virtual sensor can be changed for the user in the augmented reality view and can in particular be displaced and/or rotated. In other words, it is possible for the user to change the virtual sensor or the visualization of the virtual sensor in the augmented reality view, and in particular to displace and/or to rotate it, so that the change of the position parameter can be obtained in this way.

According to one embodiment, the display device is a mixed reality display or an augmented reality display. Preferably, the display device is augmented reality glasses, a laptop, a smartphone and/or a tablet. The display device is preferably mobile and can be moved in the real environment to change a perspective of the augmented reality view. This can enable the user to be able to constantly view new perspectives in the augmented reality view in order to check and optimize the positioning and configuration of the virtual sensor from all sides. Thus, it is, for example, conceivable that the display device is taken along by the user. If the user then moves in the real environment, the perspective of the augmented reality view can be changed such that the user can so-to-say move around the virtual sensor and view it from all sides. In this way, for example, gaps between the protective field of the virtual sensor and barriers in the real environment can be detected and eliminated. Preferably, it is conceivable that the position of the display device in the real environment is known and that a change of the position of the display device in the real environment can be tracked, for example, by means of odometry. It can preferably be possible to take screenshots of the augmented reality view at any point in time for documentation purposes.

According to one embodiment, the method further comprises creating the augmented reality view and/or creating the virtual sensor.

According to one embodiment, the augmented reality view is created by means of the display device. For this purpose, the display device can, for example, comprise a sensor, a scanner or a camera with which the real environment is scanned or captured. Additionally or alternatively, it is conceivable that the augmented reality view is created in that a position marker applied in the real environment, for example a machine-readable code, in particular a QR code or an RFID tag, is detected by means of the display device. The position marker is preferably captured by a camera included by the display device or by an RFID reading device. A model of the real environment can be obtained by the detection of the position marker. Further information, which inter alia relates to the configuration parameter of the virtual sensor and which can then be read out by the display device, can preferably also be stored on the position marker. For example, via the position marker, the information can be obtained as to which real sensor and, accordingly, which virtual sensor should be used, which and how many sensors or protective fields should be used, which sensor resolution the sensors should offer, whether and which restrictions of the positioning options exist and more.

Furthermore, it is conceivable that, by detecting the position marker, preferably an initial position of the display device can be detected in the model of the real environment. For example, the position and orientation of the display device in the real environment can be calculated from a detected optical distortion of the position marker. Additionally or alternatively, the position of the display device can be determined and tracked by means of markings and/or sensors attached in the real environment, for example cameras or radio anchors. Additionally or alternatively, the display device can comprise a GPS module for the same purpose.

Obtaining the model of the real environment allows the detection of overlaps of the field of view and/or the protective field of the virtual sensor with real objects and/or shadowing by real objects. In this way, real objects and barriers in the real environment can be taken into account. Preferably, such overlaps are identified based on the model of the real environment and visualized in the augmented reality view.

According to one embodiment, the at least one simulated parameter, in particular the position parameter and/or the configuration parameter, is visualized as at least one geometric shape in the augmented reality view. Preferably, the at least one simulated parameter is displayed in the augmented reality view as a polyhedron (e.g. as a pyramid) or as a cone. The simulated parameter is preferably displayed in the augmented reality view as a geometric shape shown in color. For example, it is conceivable that the volume limited by the geometric shape, at least one side surface of the geometric shape and/or at least one edge of the geometric shape is displayed in black, gray, white, yellow, green, red or any other possible color, or that all the side surfaces and/or edges of the geometric shape displayed in the augmented reality view are displayed in black, gray, white, yellow, green, red or any other possible color.

Preferably, the at least one simulated parameter, in particular the position parameter and/or the configuration parameter, is additionally visualized as a text display in the augmented reality view. For example, it is conceivable that assistance such as tolerance ranges of protective fields or protective volumes or the dimensions of a so-called undercreep volume (particularly relevant for cameras positioned very close to a surface, for example 30 cm above the ground) are shown that must be safeguarded by the sensor. Preferably, it is also conceivable that it is displayed which resolution which sensor can achieve at which distance. According to one embodiment, the dimensions of the protective field (i.e., for example, the length, width and/or height) of the at least one virtual sensor are visualized and/or distances of protective fields of a plurality of virtual sensors from one another are visualized and/or the distance of the protective field of the virtual sensor from a marking or a reference marker in the real environment is visualized (e.g. as numerical values in each case).

In addition to a 2D camera, the display device can also comprise a lidar sensor to detect surfaces of the real environment or to obtain surface data in another way. A surface model can thus be calculated alongside or in the positioning and configuration process (in the background). By means of the surface model, the clear distance of a protective field of the virtual sensor from a real object or a real geometry (e.g. the shortest distance) can be output. The provision of this information about the distance can be advantageous in terms of safety.

Furthermore, in particular with the aid of the surface model, it can be continuously checked during the process whether configured protective fields collide with the real geometry and a possible collision in the visualization can be displayed (e.g. by changing the color).

According to one embodiment, the resolution of the virtual sensor is visualized in dependence on the range as a shading, as a transparency gradient and/or as a color gradient in the geometric shape. In this way, a plurality of configuration parameters of the virtual sensor can be visualized together in a single geometric form for the user.

According to one embodiment, the change of the position parameter and/or the configuration parameter is obtained by user input. Thus, it is, for example, conceivable that the user can enter and/or select the desired change of the position parameter and/or the configuration parameter by means of a user interface (e.g. a GUI). In addition or alternatively, it can preferably be possible for the user to change the position parameter and/or the configuration parameter by means of a gesture or voice input that is preferably detected by a camera or a microphone. In other words, it can be possible for the user, in particular by gesture or voice control, to interactively change the position and/or the configuration of the virtual sensor in the augmented reality view and in particular to displace, rotate, expand, widen, extend, reduce and/or distort the position and/or the protective field of the virtual sensor. The voice control can preferably be supported by translating voice commands into “machine code” using a so-called Large Language Model.

It is preferably conceivable that the position parameter and/or the configuration parameter can be changed incrementally or continuously.

Additionally or alternatively, according to a further embodiment, the change of the position parameter and/or the configuration parameter is obtained by detecting at least one marking, contour and/or surface in the real environment, wherein the marking, contour and/or surface is/are preferably captured by a camera included by the display device. In this respect, the position and/or the protective field of the virtual sensor in the augmented reality view is/are preferably (automatically) oriented in the real environment based on the detected marking, contour and/or surface in the real environment. More precisely, the position and/or the protective field of the virtual sensor is/are preferably changed based on the detected marking, contour and/or surface such that, and in particular is/are displaced, rotated, expanded, widened, extended, reduced and/or distorted such that, the protective field of the virtual sensor terminates with the detected marking, contour and/or surface and/or is centered thereat and/or has or assumes a specific distance from the detected marking. In this way, the positioning and/or configuring of the virtual sensor, and in particular of a plurality of virtual sensors, in the augmented reality view can be simplified and/or accelerated. Furthermore, it can be prevented that an unwanted gap or an uncovered region remains between the protective field of the virtual sensor and a barrier in the real environment.

According to one embodiment, the updated position parameter and/or the updated configuration parameter is/are preferably fixable and/or unchangeable. The position of the virtual sensor, the orientation of the virtual sensor, the orientation of the protective field and/or the size of the protective field can preferably be fixed, wherein the respective other degree of freedom remains freely changeable. Subsequently, it is likewise conceivable that preferably the position and/or the protective field of the virtual sensor, and in particular a corner, an edge and/or a side surface of the protective field of the virtual sensor, can be automatically aligned with the marking, contour and/or surface in the real environment as described herein and can then be fixed and/or blocked for further changes. In other words, the orientation of the position and/or the protective field of the virtual sensor at the marking, contour and/or surface can preferably no longer be changed by the user so that only other degrees of freedom of the virtual sensor can be changed by the user. In this way, it can be prevented that a gap, which could possibly have been overlooked by the user, remains between the protective field of the virtual sensor and a barrier in the real environment. This allows errors to be reduced or avoided as far as possible.

According to one embodiment, a forbidden change of the position parameter and/or the configuration parameter of the virtual sensor is visualized in the augmented reality view as a color change of the geometric shape. In this way, it can for example, be interactively and immediately shown to the user if, with the change of the configuration parameter of the virtual sensor, defined tolerances for a configuration parameter of the real sensor are exceeded or if, with the change of the position parameter of the virtual sensor, a position of the virtual sensor is selected that cannot be transferred to the real sensor (because the real sensor cannot be positioned and/or connected at the corresponding position in the real environment).

According to one embodiment, a forbidden change of the position parameter and/or the configuration parameter of the virtual sensor is visualized in the augmented reality view as a color change of the geometric shape if it is determined that the changed protective field of the virtual sensor collides with a real object, is aligned with a marking in the real environment and/or detects the marking.

According to a further embodiment, the real sensor is positioned in the real environment based on the output parameter. With the real sensor positioned in the real environment, real measurement data are acquired, wherein a validation of the positioning and/or the configuration of the real sensor in the real environment is performed by comparing simulated measurement values acquired by the virtual sensor with the real measurement values. For example, a test marking and/or a test object with known dimensions, a known shape and/or a known pattern can be placed in the protective field of the positioned real sensor and real measurement data can be acquired from the test marking and/or the test object. Furthermore, measurement data acquired from the test marking or the test object are simulated with the virtual sensor. The comparison of the real measurement data with the simulated measurement data then allows a validation of the positioning and/or a configuration of the real sensor in the real environment. Thus, it is preferably conceivable that, with the test marking, the end of the protective field of the virtual sensor on a surface, and in particular a floor surface, or the line of sight of the virtual sensor in the real environment is traced or marked. In the real measurement data, it must then be recognizable that the test marking frames the field of view of the real sensor or is centered in the field of view of the real sensor in order to validate the positioning and/or configuration of the real sensor in the real environment. Additionally or alternatively, it is conceivable that an optical distortion of the test object, which distortion is recognizable in the measurement data, must match in order to validate the positioning and/or configuration of the real sensor.

According to one embodiment, (at least) one difference between the real measurement data and the simulated measurement data is recognized and/or is visualized for the user in the augmented reality view by means of the display device. In response to the visualized difference, the positioning of the real sensor in the real environment by means of the augmented reality view is/are iterated by changing and in particular by displacing and/or rotating the position of the virtual sensor in the augmented reality view and outputting an updated output parameter.

A further subject of the invention is a display device for positioning at least one real sensor, in particular a safety sensor or a camera for industrial safety applications, in a real environment of an industrial plant by means of an augmented reality view that is based on the real environment of the industrial plant. The display device according to the invention is configured to visualize at least one simulated parameter of a virtual sensor for a user in the augmented reality view, wherein the virtual sensor is based on the real sensor to be positioned, wherein the simulated parameter comprises at least one position parameter, wherein the at least one position parameter indicates a position and/or an orientation of the virtual sensor in the augmented reality view. The display device is further configured to obtain a change of the position parameter, to visualize the position parameter that is updated based on the obtained change for the user in the augmented reality view, and to output an output parameter that is based on the updated position parameter of the virtual sensor and that enables the positioning of the real sensor in the real environment.

A further subject of the invention is a system for positioning at least one real sensor, in particular a safety sensor or a camera for industrial safety applications, in a real environment of an industrial plant by means of an augmented reality view that is based on the real environment of the industrial plant, wherein the system comprises a display device described herein and the at least one real sensor.

It is understood that what is described with respect to the method according to the invention also applies to the display device and the system. This in particular applies to embodiments and advantages. Furthermore, it is to be understood that all the features and embodiments disclosed herein can be combined unless expressly stated otherwise.

The invention will be described in the following purely by way of example with reference to possible embodiments and to the enclosed drawing. There are shown:

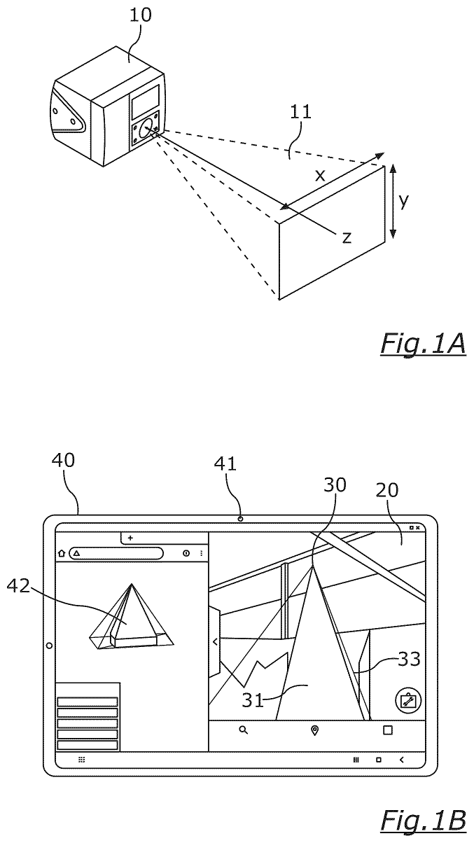

FIG. 1A a schematic representation of a real sensor of a system according to an embodiment of the invention;

FIG. 1B a schematic representation of a display device according to an embodiment of the invention;

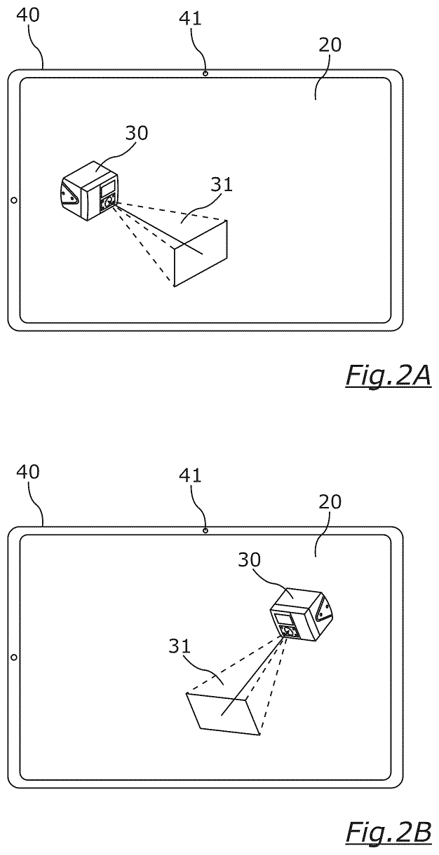

FIG. 2A a schematic representation of a display device according to an embodiment of the invention;

FIG. 2B a schematic representation of a display device according to an embodiment of the invention;

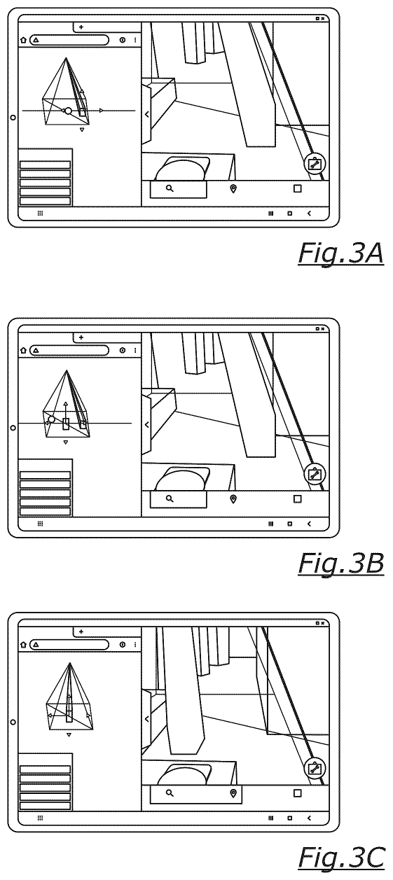

FIG. 3A a front view of a display device according to an embodiment of the invention;

FIG. 3B a front view of a display device according to an embodiment of the invention;

FIG. 3C a front view of a display device according to an embodiment of the invention;

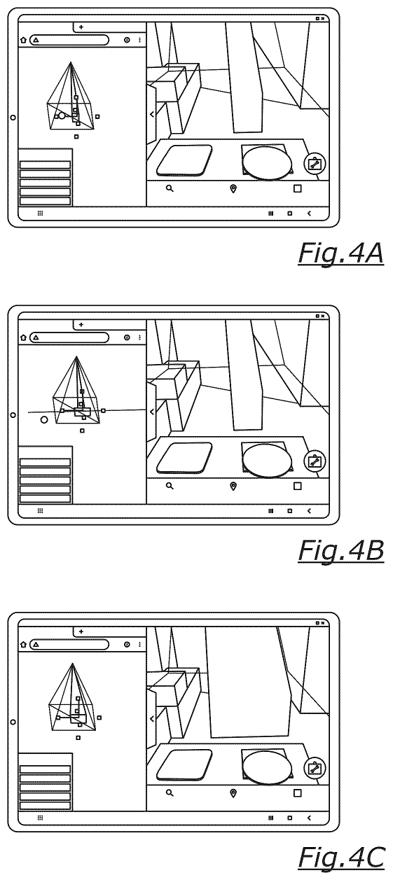

FIG. 4A a front view of a display device according to an embodiment of the invention;

FIG. 4B a front view of a display device according to an embodiment of the invention;

FIG. 4C a front view of a display device according to an embodiment of the invention;

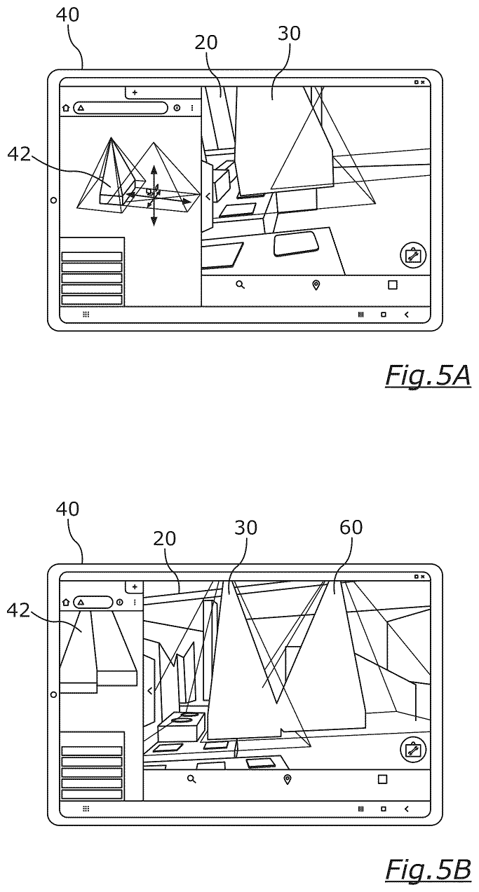

FIG. 5A a front view of a display device according to an embodiment of the invention;

FIG. 5B a front view of a display device according to an embodiment of the invention; and

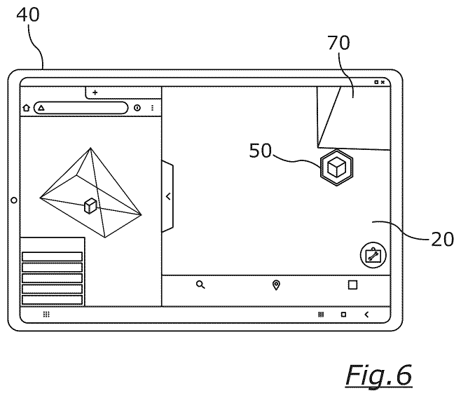

FIG. 6 a front view of a display device according to an embodiment of the invention.

FIG. 1A shows a schematic representation of an exemplary real sensor 10 as it can be used in conjunction with a method, a display device and a system according to an embodiment of the invention. The real sensor 10 preferably comprises a 3D camera and in particular a ToF camera. The protective field 11 of the real sensor 10 corresponds to the monitored zone that is detected by the sensors and that has an extent that can be seen relative to the starting point at the real sensor and/or that can also be defined in a global coordinate system by x, y and z coordinates. As shown in FIG. 1, the protective field 11 of the real sensor 10 can have the geometric shape of a pyramid.

Table 1 shows, for the example of a usable real sensor 10, the dimensions of the protective field and of the maximum field of view for certain ranges. Table 2 shows exemplary achievable ranges and remission values of a usable real sensor 10 at certain object resolutions according to the PL c (Performance Level c) of the real sensor 10. The performance level c (PL c) is a measure of the reliability of a technical safety function and is determined in a risk assessment in accordance with a machinery directive, e.g. in accordance with the DIN EN ISO 13849-1 standard, for industrial robots. The values in Table 2 indicate the range up to which an object resolution is achieved for body, hand, arm or legs or arms, legs according to PL c. The values from Table 1 and Table 2 for a real sensor can be visualized in the augmented reality view as at least one geometric shape, in particular as at least one geometric shape shown in color, and can preferably be visualized as a shading, as a transparency gradient and/or as a color gradient in the geometric shape.

TABLE 1

| | | Protective field (68° * 42°) | | Full field of view (68° * 58°) | |
|---|---|---|---|---|---|
| Range (z) | | x | y | x | y |
| 0.2 | m ^{I} | 0.27 m | 0.15 m | 0.27 m | 0.22 m |
| 0.5 | m | 0.68 m | 0.39 m | 0.68 m | 0.56 m |
| 1.0 | m | 1.35 m | 0.77 m | 1.35 m | 1.11 m |
| 1.5 | m | 2.03 m | 1.14 m | 2.03 m | 1.67 m |
| 2.0 | m ^{II} | 2.70 m | 1.51 m | 2.70 m | 2.22 m |
| 4.0 | m ^{III} | 5.40 m | 3.02 m | 5.4 m | 4.44 m |
| 7.3 | m ^{IV} | — | — | 9.85 m | 8.10 m |

^{I} smallest measurable range
^{II} largest protective field without a background
^{III} largest protective field with a background
^{IV} warning field

TABLE 2

| | Range | | Range | | Remission |
|---|---|---|---|---|---|
| Object resolution | (stationary) | | (mobile) | | (%) |
| Hand PL c | 1 | m | — | | 4 |
| Arm PL c | 1.6 | m | 1.6 | m | 4 |
| Leg PL c | 2 | m | 2 | m | 4 |
| Body PL c | 2 | m | 2 | m | 4 |
| Body PL c with an | 4 | m | 4 | m | 18 |
| enlarged scanning | | | | | |
| zone ^{I} | | | | | |
| Not safe: | 7.3 | m | 7.3 | m | 60 |
| 174 mm minimum | | | | | |
| object size in the | | | | | |
| warning field at a | | | | | |
| maximum | | | | | |
| distance of 7.3 m | | | | | |

Remission guarantee: 4% up to 2 m, 18% up to 4 m, 60% up to 7.3 m
^{I} The enlarged 4-meter scanning zone can be used if the detection zone is limited by a visible background object, for example, by a wall or the floor.
^{II} In mobile uses, the enlarged scanning zone can affect the availability of the device and is therefore not recommended by default.

The display device 40 shown schematically in FIG. 1B according to one embodiment of the invention comprises a camera 41 and a user interface 42. The display device 40 is configured to visualize simulated parameters of a virtual sensor 30 for a user in an augmented reality view 20. The virtual sensor 30 is in this respect based on a real sensor 10, as shown by way of example in FIG. 1A, to be positioned in a real environment of an industrial plant. The simulated parameters comprise at least one position parameter, which indicates a position and/or an orientation of the virtual sensor 30 in the augmented reality view 20, and at least one configuration parameter that indicates a configuration of the virtual sensor 30 that ideally corresponds to a possible configuration of a real sensor 10 as shown in FIG. 1A. The display device 40 can further be configured to create the augmented reality view in that a position marker (not shown in FIG. 1B) applied in the real environment is detected by means of the camera 41 of the display device (40).

Preferably, the display of the augmented reality view 20 and the user interface 42 can be implemented in a browser (which is typically available on an end device), both a front end (e.g. a so-called graphical user interface, GUI) and a back end (calculation and conversion). The front end can in this respect comprise certain functionalities, such as a spatial representation of 3D elements, the field of view geometries, protective fields, resolution capacity and/or detection capacity of the protective fields, and optionally the projections of the protective fields into the origins of the associated sensors. So-called user interface (UI) elements for adding, removing and manipulating the 3D elements using so-called transformation handlers (also known as handles), and UI elements for navigating in virtual space (orbit controls), i.e. moving the virtual camera, are further possible. The backend can comprise certain functionalities such as the calculation of the correct position and orientation of the individual 3D elements in the virtual space, the calculation of the correct shape of the protective fields (which are preferably cut off at the boundaries of the field of view), the calculation of the projections of the protective fields into the origins of the associated sensors, reactions to various user events and user inputs (triggered by the UI elements). Modern web technologies can be used for the implementation, such as “node.js” and/or the 3D library “Three.js”. As a result, the display size limited to mobile end devices can in particular be fully utilized. It is likewise conceivable that the augmented reality view 20 is realized by means of the so-called Vuforia Engine, a powerful software development kit (SDK) for the creation of augmented reality (AR) applications.

As shown by way of example in FIG. 1B, the position of the virtual sensor 30 together with the protective field 31 of the virtual sensor 30 and the maximum field of view 33 of the virtual sensor 30 can be visualized in the augmented reality view as a plurality of geometric shapes and in particular as pyramids. In FIG. 1B, for example, the protective field 31 of the virtual sensor 30 is visualized as a pyramid with side surfaces shown in color and the maximum field of view 33 of the virtual sensor is visualized as a pyramid with edges shown in color.

The display device 40 shown in FIG. 1B is further configured to obtain a change of the position parameter and/or the configuration parameter by user input by means of a user interface 42. As shown in FIG. 1B, the user interface 42 can comprise a GUI with an image of the virtual sensor 30 with which the user can interact by means of a computer mouse or touchpad. Preferably, the image of the virtual sensor 30 in the user interface 42 can be changed for the user by means of a computer mouse, touchpad and/or voice command and can in particular be displaced, rotated, expanded, enlarged, extended, reduced and/or distorted so that the change of the position parameter and/or the configuration parameter can be obtained as user input in this way.

FIG. 2A and FIG. 2B schematically show a display device 40 according to a further embodiment of the invention. The display device 40 shown in FIG. 2A and FIG. 2B can comprise the same or similar components and functions as the display device shown in FIGS. 1B and 1s configured to visualize the (initial) position of the virtual sensor 30 together with its field of view and/or protective field for the user in the augmented reality view 20. As shown in FIG. 2B, the display device 40 is further configured, after obtaining a change of the position parameter of the virtual sensor 30, to visualize the position parameter that is updated based on the obtained change for the user in the augmented reality view 20. The change of the position parameter can in particular comprise a displacement and/or rotation of the position and/or orientation of the virtual sensor 30. It is understood that the visualization of the maximum field of view and/or protective field of the virtual sensor 30 can be co-displaced and/or co-rotated in accordance with the displacement and/or rotation of the position and/or orientation of the virtual sensor 30. The display device 40 is further configured to output a plurality of output parameters that are based on the updated position parameter and the updated configuration parameter of the virtual sensor 30. In this way, the positioning and/or configuration of the real sensor 10 in the real environment is made possible without the real sensor 10 already having to be pre-positioned and/or connected in the real environment.

FIG. 3A, FIG. 3B and FIG. 3C show front views of a display device 40 according to a further embodiment of the invention and illustrate how the protective field 31 of the virtual sensor 30 can be changed. The user can displace, rotate, expand, enlarge, extend, reduce and/or distort the image of the virtual sensor 30 in the user interface 42, for example, by clicking and dragging with the computer mouse. The visualization of the protective field 31 of the virtual sensor 30 in the augmented reality view 20 is then updated based on the displacement, rotation, expansion, enlargement, extension and/or distortion obtained via user input and is in particular displaced, rotated, expanded, enlarged, extended, reduced and/or distorted accordingly.

FIG. 4A, FIG. 4B and FIG. 4C show front views of a display device 40 according to a further embodiment of the invention and illustrate how the protective field of the virtual sensor 30 can be changed. The user can enlarge the image of the virtual sensor 30 in the user interface 42, for example, by clicking and dragging with the computer mouse. The visualization of the protective field 31 of the virtual sensor in the augmented reality view 20 is then updated based on the enlargement obtained by user input and is in particular enlarged accordingly.

FIGS. 5A and 5B show front views of a display device 40 according to a further embodiment of the invention and illustrate how the position of the virtual sensor 30 visualized by means of a first visualization in the augmented reality view 20 can be changed. The user can, for example, add a second image of the virtual sensor 30 in the user interface 42 and can displace the second image in the user interface 42 by clicking and dragging with the computer mouse. In the augmented reality view 20, a second visualization 60 is then likewise added to the position of the virtual sensor 30 and is displayed displaced accordingly.

In FIG. 6, a front view of a display device 40 according to an embodiment of the invention is shown, in which the change of the position parameter and/or the configuration parameter is obtained by detecting a marking 50 applied in the real environment. The marking 50 is preferably captured by a camera 41 (not shown in FIG. 6) included by the display device 40 and marks the position of a real object or a barrier 70 in the real environment. The position and/or the protective field 31 of the virtual sensor 30 (not shown in FIG. 6) is/are then preferably (automatically) oriented based on the detected marking 50. More precisely, the position and/or the protective field 31 of the virtual sensor 30 is/are preferably changed based on the detected marking 50 such that, and in particular displaced, rotated, expanded, widened, lengthened, reduced and/or distorted such that, the protective field 31 of the virtual sensor 30, and in particular a corner, an edge and/or a surface of the protective field 31 of the virtual sensor 30, terminates with the detected marking 50 and/or is centered thereat and/or has or assumes a specific distance from the detected marking 50. In this way, the positioning and/or configuration of the virtual sensor 30 in the augmented reality view 20 can be accelerated. Furthermore, it can be prevented that an unwanted gap or an uncovered region remains between the protective field 31 of the virtual sensor 30 and a visualization of the real object 70 in the augmented reality view 20 and, accordingly, between the protective field 11 of the real sensor 10 (not shown in FIG. 6) and the real object 70 in the real environment. The position oriented based on the marking 50 and/or the protective field 31 of the virtual sensor 30 oriented based on the marking 50 is/are then preferably fixed and blocked for further changes by the user in order to reduce or avoid errors when changing the position and/or the protective field of the virtual sensor 30.

An output parameter is then output that is based on the updated position parameter of the virtual sensor 30 and that enables the positioning of the real sensor 10 in the real environment. The output parameter can, for example, specify in which orientation and at which radial distance or at which x, y and z coordinates the real sensor is to be positioned in a global coordinate system, which can be obtained by detecting a position marker applied in the real environment by means of the display device, starting from the position marker as an anchor point, starting from the position of the display device as an anchor point or starting from the position of the marking 50 as an anchor point. The real sensor can be positioned, and in particular mounted and/or connected, in the real environment manually or mechanically based on the output parameter. The user can, for example using a tape measure, measure the x, y and z coordinates output with the output parameter, starting from the position marker or the position of the display device (which can correspond to the position of the user), and can attach the real sensor at the corresponding position. Once the positioning of the real sensor has taken place, it is possible to align the data of the virtual sensor and the real sensor. Based on this adjustment, it can be checked whether the real sensor has been correctly positioned and/or configured.

### REFERENCE NUMERAL LIST

| | |
|---|---|
| 10 | real sensor |
| 11 | protective field of the real sensor |
| 20 | augmented reality environment |
| 30 | virtual sensor |
| 31 | protective field of the virtual sensor |
| 33 | maximum field of view of the virtual sensor |
| 40 | display device |
| 41 | camera |
| 42 | user interface |
| 50 | marking |
| 60 | second visualization of the position of the virtual sensor |
| 70 | real object |
| SICK AG | S30124PUS - Br/Sl |

1. A method for positioning at least one real sensor, in a real environment of an industrial plant by means of an augmented reality view that is based on the real environment of the industrial plant,
wherein at least one simulated parameter of a virtual sensor is visualized for a user in the augmented reality view by means of a display device, wherein the virtual sensor is based on the real sensor to be positioned, wherein the simulated parameter comprises at least one position parameter, wherein the at least one position parameter indicates a position and/or an orientation of the virtual sensor in the augmented reality view,
wherein a change of the position parameter is obtained,
wherein the position parameter that is updated based on the obtained change is visualized for the user in the augmented reality view by means of the display device, and
wherein at least one output parameter is output that is based on the updated position parameter of the virtual sensor and that enables the positioning of the real sensor in the real environment.

2. A The method according to claim 1, wherein the at least one position parameter of the virtual sensor comprises an x-coordinate value, a y-coordinate value, a z-coordinate value, and/or an alignment angle of the virtual sensor

3. A The method according to claim 1,
wherein the at least one simulated parameter of the virtual sensor that is visualized in the augmented reality view additionally comprises at least one configuration parameter,
wherein a change of the configuration parameter is obtained,
wherein the configuration parameter that is updated based on the obtained change is visualized for the user in the augmented reality view by means of the display device, and
wherein a further output parameter is output that is based on the updated configuration parameter of the virtual sensor and that enables the configuration of the real sensor in the real environment.

4. A The method according to claim 3, wherein the at least one configuration parameter of the virtual sensor comprises a maximum field of view, a portion of the maximum field of view, an orientation, a size and/or an extent of a protective field or warning field, a range, and/or a resolution of the virtual sensor.

5. A The method according to claim 1, wherein the position of the virtual sensor can be changed.

6. A The method according to claim 1, wherein the augmented reality view is created by means of the display device.

7. A The method according to claim 1, wherein the display device is a mixed reality display or an augmented reality display.

8. A The method according to claim 1, wherein the augmented reality view is created in that a position marker applied in the real environment, for example a machine-readable code is detected by means of the display device, and
a model of the real environment is obtained by the detection of the position marker, wherein, by detecting the position marker, a position of the display device can be detected in the model of the real environment.

9. A The method according to claim 1, wherein the at least one simulated parameter, is visualized as at least one geometric shape, in the augmented reality view.

10. A The method according to claim 9, wherein the resolution of the virtual sensor is visualized in dependence on the range as a shading, as a transparency gradient and/or as a color gradient in the geometric shape.

11. The method according to claim 1,
wherein the change of the position parameter and/or the configuration parameter is obtained by user input, and/or
wherein the change of the position parameter and/or the configuration parameter is obtained by detecting at least one marking, contour and/or surface in the real environment.

12. The method according to claim 1, wherein the updated position parameter and/or the updated configuration parameter is/are fixable and/or unchangeable.

13. The method according to claim 1, wherein a forbidden change of the position parameter and/or the configuration parameter of the virtual sensor is visualized in the augmented reality view as a color change of the geometric shape.

14. The method according to claim 1, wherein the real sensor is positioned in the real environment based on the output parameter, wherein the real sensor positioned in the real environment acquires real measurement data, wherein a validation of the positioning and/or the configuration of the real sensor in the real environment is performed by comparing simulated measurement data acquired by the virtual sensor with the real measurement data.

15. The method according to claim 14, wherein a difference between the real measurement data and the simulated measurement data is recognized and/or is visualized for the user in the augmented reality view by means of the display device, and wherein, in response to the visualized difference, the positioning and/or the configuration of the real sensor in the real environment is/are iterated by means of the augmented reality view by changing the position of the virtual sensor in the augmented reality view and outputting an updated output parameter.

16. A display device for positioning at least one real sensor in a real environment of an industrial plant by means of an augmented reality view that is based on the real environment of the industrial plant, wherein the display device is configured to visualize at least one simulated parameter of a virtual sensor for a user in the augmented reality view, wherein the virtual sensor is based on the real sensor to be positioned, wherein the simulated parameter comprises at least one position parameter, wherein the at least one position parameter indicates a position and/or an orientation of the virtual sensor in the augmented reality view,
to obtain a change of the position parameter,
to visualize the position parameter that is updated based on the obtained change for the user in the augmented reality view, and
to output an output parameter that is based on the updated position parameter of the virtual sensor and that enables the positioning of the real sensor in the real environment.

17. A system for positioning at least one real sensor in a real environment of an industrial plant by means of an augmented reality view that is based on the real environment of the industrial plant, wherein the system comprises a display device according to claim 16 and the at least one real sensor.

18. The method according to claim 5, wherein the position of the virtual sensor can be displaced and/or rotated for the user in the augmented reality view.

19. The method according to claim 7, wherein the display device is mobile and can be moved in the real environment in order to change a perspective of the augmented reality view.

20. The method according to claim 8, wherein the position marker is a machine-readable code.

21. The method according to claim 8, wherein, by detecting the position marker, an initial position of the display device can be detected in the model of the real environment.

22. The method according to claim 9, wherein the at least one simulated parameter comprises the position parameter and/or the configuration parameter.

23. The method according to claim 11,
wherein the position and/or the protective field of the virtual sensor in the augmented reality view is/are oriented based on the detected marking, contour and/or surface in the real environment.

24. The method according to claim 23,
wherein the position and/or the protective field of the virtual sensor is/are changed based on the detected marking, contour and/or surface such that the protective field of the virtual sensor terminates with the detected marking, contour and/or surface and/or is centered at the detected marking and/or has a specific distance from the detected marking.

25. The method according to claim 15, wherein, in response to the visualized difference, the positioning and/or the configuration of the real sensor in the real environment is/are iterated by means of the augmented reality view by changing and by displacing and/or rotating the position of the virtual sensor in the augmented reality view and outputting an updated output parameter.
